(19) United States
(12) Patent Application Publication
(10) Pub. No.: US 2025/0298170 A1
(43) Pub. Date: Sep. 25, 2025

(54) SILVER-CONTAINING POLARIZING GLASS AND OPTICAL ISOLATOR

(71) Applicant: HOYA CORPORATION, Tokyo (JP)

(72) Inventors: Katsuyuki MUKOGAWA, Tokyo (JP); Yoshitaka YONEDA, Tokyo (JP)

(73) Assignee: HOYA CORPORATION, Tokyo (JP)

(21) Appl. No.: 19/077,712

(22) Filed: Mar. 12, 2025

(30) Foreign Application Priority Data
Mar. 22, 2024 (JP) 2024-046558

(51) Int. Cl. G02B 1/08; C03B 23/00; C03C 3/097

(52) U.S. Cl. CPC G02B 1/08; C03C 3/097; C03B 23/0006

(57) ABSTRACT

A polarizing glass includes shape-anisotropic metal particles oriented and dispersed in at least a surface layer of a glass substrate. The glass substrate contains, by mass %, SiO₂: 50.0 to 60.0%, B₂O₃: 10.0 to 25.0%, Al₂O₃: 3.0 to 10.0%, a total amount of Li₂O, Na₂O, and K₂O [Li₂O+Na₂O+K₂O]: 5.0 to 20.0%, ZrO₂: 2.0 to 8.0%, TiO₂: 0.1 to 5.0%, Nb₂O₅: 0.1 to 5.0%, a total amount of TiO₂ and Nb₂O₅[TiO₂+Nb₂O₅]: 0.2 to 10.0%, Ag, and Cl and/or Br: equal to or larger than a chemical equivalent of Ag. The shape-anisotropic metal particles are metallic Ag particles.

### BACKGROUND OF THE INVENTION

The present invention relates to a polarizing glass used in an optical component, for example, an optical isolator or the like, particularly to a polarizing glass containing shape-anisotropic metallic silver particles.

An optical isolator has a function of transmitting only light traveling in a forward direction and blocking light traveling in a reverse direction. A polarizing glass is an optical glass that transmits only light that vibrates in a specific direction (polarized light), and is an optical component used in an optical isolator and the like. Currently, the optical isolator is used in a variety of environments, and excellent durability is required for the polarizing glass.

In addition, in the polarizing glass, when the glass that is a substrate is discolored due to light irradiation or the like, the function of the polarizing glass may be reduced. Specifically, a phenomenon known as photochromism in which the glass substrate darkens due to irradiation with ultraviolet light or short-wavelength visible light occurs, and the amount of light transmitting through the polarizing glass decreases, which is a problem.

Namely, a polarizing glass including a glass substrate having excellent durability in a variety of environments and having reduced photochromic properties is required.

Patent Document 1 discloses a polarizing glass containing shape-anisotropic metallic silver particles; however, the amount of Al₂O₃ or ZrO₂ is small, it is not assumed that the polarizing glass is used in a variety of environments, and there is no mention of durability. In addition, Patent Document 2 discloses a polarizing glass containing dispersed shape-anisotropic metallic silver particles; however, it is not assumed that a glass substrate is discolored due to light irradiation or the like, and there is no disclosure of reducing photochromic properties of the glass by containing a predetermined amount of Nb₂O₅ or the like. Patent Document 3 discloses polarizing materials containing silver as flattened metal particles in a glass substrate material; however, in any cases, the amount of silver is high, and there is no mention of reducing the amount of introduction of silver.

### CITATION LIST

### Patent Document

Patent Document 1: JP S56-169140 A
Patent Document 2: JP 2013-126921 A
Patent Document 3: JP 2010-150132 A

### SUMMARY OF THE INVENTION

The present invention has been made in view of such circumstances, and an object of the present invention is to provide a polarizing glass including a glass substrate having excellent chemical durability and reduced photochromic properties.

The concept of the present invention is as follows.

(1) A polarizing glass includes shape-anisotropic metal particles oriented and dispersed in at least a surface layer of a glass substrate. The glass substrate contains, by mass %, SiO₂: 50.0 to 60.0%, B₂O₃: 10.0 to 25.0%, Al₂O₃: 3.0 to 10.0%, a total amount of Li₂O, Na₂O, and K₂O [Li₂O+Na₂O+K₂O]: 5.0 to 20.0%, ZrO₂: 2.0 to 8.0%, TiO₂: 0.1 to 5.0%, Nb₂O₅: 0.1 to 5.0%, a total amount of TiO₂ and Nb₂O₅[TiO₂+Nb₂O₅]: 0.2 to 10.0%, Ag, and Cl and/or Br: equal to or larger than a chemical equivalent of Ag. The shape-anisotropic metal particles are metallic Ag particles.

(2) An optical isolator includes the polarizing glass according to the above (1).

According to the present invention, the polarizing glass including the glass substrate having excellent chemical durability and reduced photochromic properties can be provided.

### BRIEF DESCRIPTION OF THE DRAWINGS

FIG. 1 is a schematic side cross-sectional view schematically showing an optical system of a free-space optical isolator;

FIG. 2 is a schematic side cross-sectional view schematically showing an optical system of a pigtail optical isolator; and

FIG. 3 is a photograph showing the degree of discoloration of drawn glasses prepared in Example and Comparative Example.

### DETAILED DESCRIPTION OF THE PREFERRED EMBODIMENTS

In the present invention and this specification, a glass composition is expressed on an oxide basis unless otherwise specified. Here, the “glass composition on an oxide basis” refers to a glass composition obtained by converting all glass raw materials into oxides that exist in the glass after being completely decomposed during melting, and each glass component is expressed as SiO₂, TiO₂, or the like in accordance with the notation convention. In addition, elements Ag, Cl, and Br related to polarization properties are expressed as elements rather than as oxides. The amount and the total amount of the glass components are based on mass unless otherwise specified, and “%” means “mass %”.

The amount of each glass component can be quantified by a known method, for example, inductively coupled plasma atomic emission spectroscopy (ICP-AES), inductively coupled plasma mass spectrometry (ICP-MS), or the like. In addition, in this specification and the present invention, the amount of a component being 0% means that the component is substantially not contained, and the component is permitted to be contained at an inevitable impurity level.

In this specification, the chemical durability of glass refers to excellent water resistance and acid resistance. In addition, the thermal stability of glass refers to a difficulty in depositing crystals other than silver halide particles when molten glass solidifies.

Hereinafter, one embodiment of the present invention will be described.

A polarizing glass according to the present embodiment includes a glass substrate, and contains shape-anisotropic metal particles oriented and dispersed in at least a surface layer of the glass substrate. The polarizing glass has the function of transmitting polarized light in a specific vibration direction (referred to as a “polarization transmission axis”) and absorbing polarized light in a direction orthogonal to the specific vibration direction (referred to as a “polarization extinction axis”).

### (Glass Substrate)

In the glass substrate, the amount of SiO₂ is 50.0 to 60.0%. The lower limit of the amount of SiO₂ is preferably 51.0%, and more preferably 52.0%. In addition, the upper limit of the amount of SiO₂ is preferably 59.0%, and more preferably 58.0%. The chemical durability of the glass substrate can be improved by setting the amount of SiO₂ within the above-described range. Meanwhile, when the amount of SiO₂ is too low, the chemical durability and the thermal stability of the glass substrate may decrease. In addition, when the amount of SiO₂ is too high, the meltability of the glass may decrease.

In the glass substrate, the amount of B₂O₃ is 10.0 to 25.0%. The lower limit of the amount of B₂O₃ is preferably 12.0%, and more preferably 13.0% and 14.0% in that order. The upper limit of the amount of B₂O₃ is preferably 23.0%, and more preferably 21.0% and 20.0% in that order. The chemical durability of the glass substrate can be improved by setting the amount of B₂O₃ within the above-described range. Meanwhile, when the amount of B₂O₃ is too low, the meltability of the glass may decrease, and silver halide particles may not be favorably deposited in the entire glass substrate during heat treatment to be described later. In addition, when the amount of B₂O₃ is too high, the chemical durability of the glass substrate may decrease.

In the glass substrate, the amount of Al₂O₃ is 3.0 to 10.0%. The lower limit of the amount of Al₂O₃ is preferably 4.0%, and more preferably 4.5%. In addition, the upper limit of the amount of Al₂O₃ is preferably 9.0%, and more preferably 8.0%. The chemical durability of the glass substrate can be improved by setting the amount of Al₂O₃ within the above-described range. Meanwhile, when the amount of Al₂O₃ is too low, the chemical durability of the glass substrate may decrease significantly. In addition, when the amount of Al₂O₃ is too high, the meltability of the glass may decrease and the glass may become prone to devitrification.

In the glass substrate, the total amount of Li₂O, Na₂O, and K₂O[Li₂O+Na₂O+K₂O] is 5.0 to 20.0%. The lower limit of the total amount is preferably 7.0%, and more preferably 9.0%. In addition, the upper limit of the total amount is preferably 18.0%, and more preferably 16.0%. The chemical durability of the glass substrate can be improved by setting the total amount within the above-described range. Particularly, the chemical durability of the glass substrate can be improved by containing two or more alkali metals. Meanwhile, when the total amount is too low, the meltability of the glass may decrease. In addition, when the total amount is too high, silver halide particles may not be favorably deposited in the entire glass substrate during heat treatment to be described later.

In the glass substrate, the amount of ZrO₂ is 2.0 to 8.0%. The lower limit of the amount of ZrO₂ is preferably 2.5%, and more preferably 3.0%. In addition, the upper limit of the amount of ZrO₂ is preferably 7.7%, and more preferably 7.0%. The chemical durability of the glass substrate can be improved by setting the amount of ZrO₂ within the above-described range. Meanwhile, when the amount of ZrO₂ is too low, the chemical durability of the glass substrate may decrease significantly. In addition, when the amount of ZrO₂ is too high, the meltability of the glass may decrease and the liquidus temperature may increase.

In the glass substrate, the amount of TiO₂ is 0.1 to 5.0%. The lower limit of the amount of TiO₂ is preferably 0.3%, and more preferably 0.6%. In addition, the upper limit of the amount of TiO₂ is preferably 4.5%, and more preferably 4.0%. TiO₂ is a glass component that contributes to improving the chemical durability of the glass and that absorbs light from near-ultraviolet to visible short wavelengths well. Therefore, the polarizing glass including the glass substrate having improved chemical durability and reduced photochromic properties can be obtained by setting the amount of TiO₂ within the above-described range. Meanwhile, when the amount of TiO₂ is too low, the chemical durability of the glass substrate may decrease and the photochromic properties of the glass substrate may increase. In addition, when the amount of TiO₂ is too high, the meltability of the glass may decrease, the liquidus temperature may increase, and coloration may become intensified during glass molding.

In the glass substrate, the amount of Nb₂O₅ is 0.1 to 5.0%. The lower limit of the amount of Nb₂O₅ is preferably 0.3%, and more preferably 0.6%. In addition, the upper limit of the amount of Nb₂O₅ is preferably 4.5%, and more preferably 4.0%. Nb₂O₅ is a glass component that absorbs light well from near-ultraviolet to visible short wavelengths. Therefore, the polarizing glass including the glass substrate having reduced photochromic properties can be obtained by setting the amount of Nb₂O₅ within the above-described range. Meanwhile, when the amount of Nb₂O₅ is too low, the photochromic properties of the glass substrate may increase. In addition, when the amount of Nb₂O₅ is too high, the meltability of the glass may decrease, the liquidus temperature may increase, and coloration may become intensified during glass molding.

In the glass substrate, the total amount of TiO₂ and Nb₂O₅[TiO₂+Nb₂O₅] is 0.2 to 10.0%. The lower limit of the total amount is preferably 0.5%, and more preferably 1.0%. In addition, the upper limit of the total amount is preferably 9.0%, and more preferably 8.0%. The polarizing glass including the glass substrate having improved chemical durability and reduced photochromic properties can be obtained by setting the total amount within the above-described range. Meanwhile, when the total amount is too low, the chemical durability of the glass substrate may decrease and the photochromic properties of the glass substrate may increase. In addition, when the total amount is too high, the meltability of the glass may decrease and the liquidus temperature may increase.

The glass substrate contains Ag, Cl, and Br. In the glass substrate, the lower limit of the amount of Ag is preferably 0.10%, and more preferably 0.11% and 0.13% in that order. In addition, the upper limit of the amount of Ag is preferably 1.0%, and more preferably 0.8% and 0.6% in that order. The polarizing glass including the glass substrate having excellent chemical durability can be obtained by causing the glass substrate to contain Ag. Meanwhile, when the amount of Ag is too low, silver halide particles may not be favorably deposited in the entire glass substrate during heat treatment to be described later. In addition, when the amount of Ag is too high, the insertion loss may increase, and when the glass is melted and cooled silver halide particles may deposit in the glass and the particle size of the silver halide particles may become difficult to control.

Incidentally, it is preferable that the glass substrate does not substantially contain Cu. Namely, it is preferable that the amount of Cu is 0%.

In order to deposit silver halide particles in the entire glass substrate, Ag is added to the glass substrate raw materials, for example, as AgCl and AgBr. However, since AgBr is a hazardous substance, AgBr needs to be handled with care, and it is preferable that AgBr is not used from an environmental standpoint. In addition, since Cl and Br are likely to volatilize during melting of the glass, Cl and Br are added in excess as alkali metal or alkaline earth metal chlorides or bromides for replenishment. Therefore, the glass substrate contains Cl and/or Br in an amount equal to or larger than the chemical equivalent of Ag. It is preferable that the amount of Cl and Br added in excess is adjusted depending on the glass melting method or scale.

As described above, the glass substrate contains Cl and/or Br in an amount equal to or larger than the chemical equivalent of Ag. That is, in the glass substrate, the chemical equivalent of at least one of Cl and Br is equal to or larger than the chemical equivalent of Ag. The chemical equivalents of both Cl and Br may be equal to or larger than the chemical equivalent of Ag.

The Iwanami Dictionary of Physics and Chemistry (5th edition) defines chemical equivalent as “a given quantity of an element (simple substance) or compound determined based on its chemical reactivity. It is also simply called equivalent.” The chemical equivalent of an element is also defined as “When the mass of an element that combines with 7.999 g of oxygen (corresponding to ½ mol of oxygen atoms) is W g, W is called the chemical equivalent of that element. The chemical equivalent of an element that does not directly combine with oxygen can be determined by using an appropriate element other than oxygen as an intermediary.”

In the present embodiment, according to the above description in the Iwanami Dictionary of Physics and Chemistry, the chemical equivalent of Ag, Cl, or Br corresponds to the chemical equivalent of the element. That is, the chemical equivalent of Cl is the amount of Cl expressed in mass % divided by the atomic weight of Cl, the chemical equivalent of Br is the amount of Br expressed in mass % divided by the atomic weight of Br, and the chemical equivalent of Ag is the amount of Ag expressed in mass % divided by the atomic weight of Ag. Thus, the chemical equivalent of Cl and/or Br is equal to or larger than the chemical equivalent of Ag means that the number of Cl atoms and/or the number of Br atoms contained in the glass is equal to or larger than the number of Ag atoms contained in the glass.

In the glass substrate, the total amount of Cl and Br is preferably 0.05 to 2.0%. The amount of Cl is preferably 0.05 to 1.0%. Similarly, the amount of Br is preferably 0.05 to 1.0%.

Non-limiting examples of the amounts of glass components other than those described above in the glass substrate are provided below.

In the glass substrate, the lower limit of the amount of Li₂O is preferably 0.0%, and more preferably 0.5% and 0.8% in that order. In addition, the upper limit of the amount of Li₂O is preferably 5.0%, and more preferably 4.0% and 3.5% in that order.

From the viewpoint of improving the meltability of the glass and lowering the glass transition temperature Tg, it is preferable that the lower limit of the amount of Li₂O is set as described above. In addition, from the viewpoint of favorably depositing silver halide particles in the entire glass substrate during heat treatment to be described later, it is preferable that the upper limit of the amount of Li₂O is set as described above.

In the glass substrate, the lower limit of the amount of Na₂O is preferably 0.0%, and more preferably 1.0% and 3.0% in that order. In addition, the upper limit of the amount of Na₂O is preferably 10.0%, and more preferably 8.0% and 7.0% in that order. From the viewpoint of improving the meltability of the glass and lowering the glass transition temperature Tg, it is preferable that the lower limit of the amount of Na₂O is set as described above. In addition, from the viewpoint of favorably depositing silver halide particles in the entire glass substrate during heat treatment to be described later, it is preferable that the upper limit of the amount of Na₂O is set as described above.

In the glass substrate, the lower limit of the amount of K₂O is preferably 0.0%, and more preferably 1.0% and 3.0% in that order. In addition, the upper limit of the amount of K₂O is preferably 10.0%, and more preferably 8.0% and 7.0% in that order.

From the viewpoint of improving the meltability of the glass and lowering the glass transition temperature Tg, it is preferable that the lower limit of the amount of K₂O is set as described above. In addition, from the viewpoint of favorably depositing silver halide particles in the entire glass substrate during heat treatment to be described later, it is preferable that the upper limit of the amount of K₂O is set as described above.

In the glass substrate, the lower limit of the amount of MgO is preferably 0.0%. The amount of MgO may be 0.0%. In addition, the upper limit of the amount of MgO is preferably 5.0%, and more preferably 3.0%. From the viewpoint of improving the thermal stability and meltability of the glass, it is preferable that the amount of MgO is set within the above-described range.

In the glass substrate, the lower limit of the amount of CaO is preferably 0.0%. The amount of CaO may be 0.0%. In addition, the upper limit of the amount of CaO is preferably 5.0%, and more preferably 3.0%. From the viewpoint of improving the thermal stability and meltability of the glass, it is preferable that the amount of CaO is set within the above-described range.

In the glass substrate, the lower limit of the amount of SrO is preferably 0.0%. The amount of SrO may be 0.0%. In addition, the upper limit of the amount of SrO is preferably 5.0%, and more preferably 3.0%. From the viewpoint of improving the thermal stability and meltability of the glass, it is preferable that the amount of SrO is set within the above-described range.

In the glass substrate, the lower limit of the amount of BaO is preferably 0.0%. The amount of BaO may be 0.0%. In addition, the upper limit of the amount of BaO is preferably 5.0%, and more preferably 3.0%. From the viewpoint of suppressing an increase in specific gravity, it is preferable that the amount of BaO is set within the above-described range.

In the glass substrate, the lower limit of the total amount of MgO, CaO, SrO, and BaO [MgO+CaO+SrO+BaO] is preferably 0.0%. The total amount may be 0.0%. In addition, the upper limit of the total amount is preferably 5.0%, and more preferably 3.0%. MgO, CaO, SrO, and BaO have the effect of improving the thermal stability and meltability of the glass and increasing the basicity of the glass to prevent reduction of silver, but may reduce the chemical durability of the glass substrate, so that the total amount is set within the above-described range.

In the glass substrate, the lower limit of the amount of ZnO is preferably 0.0%. The amount of ZnO may be 0.0%. In addition, the upper limit of the amount of ZnO is preferably 5.0%, and more preferably 3.0%. From the viewpoint of improving the thermal stability of the glass, it is preferable that the amount of ZnO is set within the above-described range.

It is preferable that the glass substrate mainly consists of the above-described glass components, namely, SiO₂, B₂O₃, Al₂O₃, ZrO₂, TiO₂, Nb₂O₅, Ag, Cl, Br, Li₂O, Na₂O, K₂O, MgO, CaO, SrO, BaO, and ZnO, and the total amount of the above-described glass components is preferably 95% or more, more preferably 98% or more, still more preferably 99% or more, and even more preferably 99.5% or more.

It is preferable that the glass substrate essentially consists of the above-described glass components, but can also contain other components as long as the other components do not impair the actions and effects of the present invention. In addition, the present invention does not exclude the containment of inevitable impurities.

Incidentally, the glass substrate is mainly formed of an oxide. Namely, the main anion component in the glass substrate is O, and the glass substrate can also contain trace amounts of Cl and Br. The glass substrate may contain F as an anion component other than 0, Cl, and Br. In the glass substrate, the amount of F is preferably 0.5% or less, and more preferably 0.0%.

### (Other Components)

In the glass substrate, the lower limit of the amount of CeO₂ is preferably 0.0%. The amount of CeO₂ may be 0.0%. In addition, the upper limit of the amount of CeO₂ is preferably 3.0%, and more preferably 1.0%. CeO₂ is a component that functions as a fining agent for glass. In addition, the states of Ce⁴⁺ ions and Ce³⁺ ions coexist in the glass, and normally act to maintain the oxidation state of Ag⁺ ions; however, since the equilibrium of the valence state easily changes depending on temperature, Ag⁺ ions are conversely reduced during heat treatment to deposit silver halide particles, and as a result, photochromism may be promoted. Therefore, it is preferable that the amount of CeO₂ is set within the above-described range.

Pb is a component that is toxic and of concern due to the environmental load. Therefore, it is preferable that the glass substrate does not substantially contain Pb. Namely, it is preferable that the amount of Pb is 0% when converted into an oxide.

Cd, As, Th, and the like are components that are of concern due to the environmental load.

Therefore, the amount of each of CdO, ThO₂, and As₂O₃ is preferably 0 to 0.1%, more preferably 0 to 0.05%, even more preferably 0 to 0.01%, and particularly preferably, CdO, ThO₂, and As₂O₃ are substantially not contained.

It is preferable that the glass substrate does not contain coloring elements. Co, Ni, Fe, Cr, Eu, Nd, Er, and the like can be provided as examples of the coloring elements. Each of these elements is preferably less than 100 ppm by mass, more preferably 0 to 80 ppm by mass, still more preferably 0 to 50 ppm by mass or less, and particularly preferably substantially not contained.

In addition, Ga, Te, Tb, and the like are components that do not need to be introduced, and are expensive components. Therefore, the range of the amount of each of Ga₂O₃, TeO₂, and TbO₂ expressed by mass % is preferably 0 to 0.1%, more preferably 0 to 0.05%, still more preferably 0 to 0.01%, even more preferably 0 to 0.005%, most preferably 0 to 0.001%, and particularly preferably, Ga₂O₃, TeO₂, and TbO₂ are not substantially contained.

### (Properties of Glass Substrate)

### <Chemical Durability: Water Resistance Dw>

In the glass substrate, a water resistance Dw is preferably Class 3 or higher, more preferably Class 2 or higher, and still more preferably Class 1.

The water resistance Dw can be evaluated by the method shown in JOGIS 06:2019. Namely, the water resistance Dw is evaluated by placing powdered glass (particle size 425 to 600 μm) of a mass equivalent to the specific gravity in a platinum basket, immersing the platinum basket in a round bottomed flask of glass quartz containing 80 mL of pure water (pH=6.5 to 7.5), treating the powdered glass in a boiling water bath for 60 minutes, and classifying the powdered glass into the classes in Table A according to the mass loss rate (%).

TABLE A

| Class | Mass loss (%) |
|---|---|
| 1 | Less than 0.05% |
| 2 | 0.05% or more but less than 0.10% |
| 3 | 0.10% or more but less than 0.25% |
| 4 | 0.25% or more but less than 0.60% |
| 5 | 0.60% or more but less than 1.10% |
| 6 | 1.10% or more |

### <Chemical Durability: Acid Resistance Da>

In the glass substrate, an acid resistance Da is preferably Class 3 or higher, more preferably Class 2 or higher, and still more preferably Class 1.

The acid resistance Da can be evaluated by the method shown in JOGIS 06:2019. Namely, the acid resistance Da is evaluated by placing powdered glass (particle size 425 to 600 μm) of a mass equivalent to the specific gravity in a platinum basket, immersing the platinum basket in a round bottomed flask of glass quartz containing 80 mL of 0.01 mol/L nitric acid water solution, treating the powdered glass in a boiling water bath for 60 minutes, and classifying the powdered glass into the classes in Table B according to the mass loss rate (%).

TABLE B

| Class | Mass loss (%) |
|---|---|
| 1 | Less than 0.20% |
| 2 | 0.20% or more but less than 0.35% |
| 3 | 0.35% or more but less than 0.65% |
| 4 | 0.65% or more but less than 1.20% |
| 5 | 1.20% or more but less than 2.20% |
| 6 | 2.20% or more |

### (Shape-Anisotropic Metal Particle)

The polarizing glass according to the present embodiment contains shape-anisotropic metal particles oriented and dispersed in at least the surface layer of the glass substrate, and the shape-anisotropic metal particles are metallic Ag particles. In the polarizing glass according to the present embodiment, the surface layer containing the shape-anisotropic silver particles constitutes a part including the surface of the glass substrate or the entirety of the glass substrate, and the thickness of the surface layer is, for example, 20 to 100 μm. In addition, the dimension of the shape-anisotropic metallic silver particles in a direction along the major axis of silver halide particles is, for example, within a range of 10 to 1000 nm, and the ratio of the dimension to a dimension in a direction perpendicular to the direction (aspect ratio) is, for example, within a range of 0.5 to 20.

### <Extinction Ratio and Insertion Loss>

Generally, the optical properties required for polarizing glass are a high extinction ratio and a low insertion loss. The “extinction ratio” is the ratio of transmittance of light in a direction parallel to the polarization extinction axis to light in a direction parallel to the polarization transmission axis, and the higher the extinction ratio is, the more excellent the optical properties are. The unit is dB. In addition, the “insertion loss” refers to a loss that light parallel to the polarization transmission axis incurs when transmitting through a polarizing element, and the lower the insertion loss is, the more excellent the optical properties are. The unit is dB.

As shown in FIG. 13 of Japan Patent No. 4642921 for which the present inventor is the inventor, when the distance (measurement distance) between a polarizing glass and a power meter of a detector is as short as 5 mm, the detector receives re-emitted light from the polarizing glass, so that the extinction ratio decreases by the amount of the re-emitted light. When the measurement distance is as long as 300 mm, the detector is less likely to receive re-emitted light from the polarizing glass, so that the extinction ratio becomes high. Therefore, when the distance between the polarizing glass and the power meter is short, the extinction ratio becomes low, and when the distance is long, the extinction ratio becomes high. The insertion loss is independent of the measurement distance, and is a substantially constant value.

In the polarizing glass according to the present embodiment, the extinction ratio for light having a wavelength of 1270 nm at a measurement distance of 5 mm is preferably 38.0 dB or more, and more preferably 38.2 dB or more. In addition, the extinction ratio for light having a wavelength of 1650 nm at a measurement distance of 300 mm is preferably 55.0 dB or more, and more preferably 56.0 dB or more.

In the polarizing glass according to the present embodiment, when an anti-reflection film is applied to one surface of the polarizing glass, it is preferable that the insertion loss for light having a wavelength of 1270 nm at a measurement distance of 5 mm is 0.204 dB or less, and it is preferable that the insertion loss for light having a wavelength of 1650 nm at a measurement distance of 300 mm is 0.204 dB or less.

The extinction ratio and the insertion loss of the polarizing glass can be measured as follows. A semiconductor laser light source and a Glan-Thompson prism are disposed on one side of the polarizing glass, and a detector (power meter) is disposed on the other side of the polarizing glass. The Glan-Thompson prism is inserted to obtain a linearly polarized wave in a specific direction.

The extinction ratio is obtained using the following equation by rotating the polarizing glass to measure a minimum transmitted light amount P₁ and rotating the polarizing glass by 90 degrees to measure a maximum transmitted light amount P₂.

$$Extinction ratio ( dB ) = - 10 Log ( {P}_{1} / {P}_{2} )$$

The insertion loss is obtained using the following equation by measuring a light amount P₀ in a state where the polarizing glass is absent.

$$Insertion loss ( dB ) = - 10 Log ( {P}_{2} / {P}_{0} )$$

### (Polarizing Glass Manufacturing Method)

A polarizing glass manufacturing method according to the present embodiment is roughly divided into steps of (A) mixing and melting glass raw materials, (B) depositing silver halide particles, (C) drawing a glass substrate material, and (D) reduction.

### [(a) Mixing and Melting of Glass Raw Materials]

The mixing of the glass raw materials is performed. As the glass raw materials, for example, SiO₂, H₃BO₃, Al(OH)₃, Li₂CO₃, Na₂CO₃, K₂CO₃, KNO₃, ZrO₂, TiO₂, Nb₂O₅, NaCl, NaBr, and AgCl are used. The glass raw materials are placed into a platinum crucible, and are melted at about 1300° C. to 1500° C. Thereafter, the glass raw materials are molded and slowly cooled to room temperature to obtain a glass substrate material.

### [(B) Deposition of Silver Halide Particles]

The glass substrate material obtained in the above (A) is heat-treated at a temperature of 650° C. to 800° C. for approximately several to 20 hours (preferably, approximately 4 to 10 hours). In order to form silver halide particles of an appropriate size, generally, it is preferable that when the heat treatment time is short, heat treatment is performed at a high temperature, and when the heat treatment time is long, heat treatment is performed at a relatively low temperature.

When the glass contains AgCl as a silver halide, the above-described heat treatment causes Cl ions, Br ions, and Ag ions to aggregate, and AgClBr particles in a liquid state are deposited. In the subsequent cooling step, when the temperature of the glass decreases to near the glass transition temperature (Tg), for example, to near 500° C., the glass is maintained in a glassy state. Even in this state, AgClBr exists as a liquid; however, when the temperature of the glass further decreases and falls below the melting point of AgClBr, which is 420 to 460° C., AgClBr undergoes a phase change from liquid to solid. Although not limited, the deposited silver halide particles (AgClBr) are formed as substantially spherical bodies. Incidentally, AgClBr is, precisely, AgCl₍ₓ₎Br₍₁₋ₓ₎(0<x<1).

### [(C) Drawing of Glass Substrate Material]

The glass substrate material in which the silver halide particles are deposited is heated and unidirectionally drawn. For example, the heating temperature in the drawing step can be set to 550° C. to 650° C., and the tensile force in the drawing step can be set to approximately 25 MPa to 50 MPa. AgClBr changes from solid to liquid due to heating and drawing, and undergoes a phase change to solid again when the temperature falls below the melting point of AgClBr. Through the drawing step, all the silver halide particles are changed to a shape elongated in substantially the same direction.

### [(D) Reduction]

The glass substrate material in which the silver halide particles are unidirectionally extended long is reduced to obtain a polarizing glass. The reduction step is performed at a temperature equal to or lower than the glass transition temperature (Tg), for example, in a hydrogen atmosphere. For this reason, the silver halide particles are reduced to metallic Ag particles while the glass structure maintains a glassy state.

In the reduction step, the region of the silver halide particles that are unidirectionally extended long is maintained as it is and becomes a cavity, and one or a plurality of divided shape-anisotropic metallic Ag particles are formed in the cavity.

Here, in the above-described step (B), when the deposition temperature is increased, the volume of silver halide particles to be deposited increases, and it becomes difficult to control the dimension of metallic Ag particles, which are obtained by reducing the silver halide particles, in a direction perpendicular to a direction along the major axis of the silver halide particles to be small. In order to obtain excellent optical properties, it is preferable that the average value of the dimension of the metallic Ag particles in the direction perpendicular to the direction along the major axis of the silver halide particles is 20 nm or less. In order to suppress an increase in the volume of the silver halide particles to be deposited, in the heat treatment during the deposition step (B), for example, when the heat treatment time is 8 hours, the temperature can be set within a range of 690° C. to 710° C.

### Application

The polarizing glass according to the present embodiment can be applied to any optical device in which a polarizing glass is used, and there is no particular limitation on the application. For example, the polarizing glass according to the present embodiment can be used as a polarizing glass for pigtail optical isolators in wavelength bands used in optical communication.

### (Optical Isolator)

An optical isolator has the function of transmitting only light traveling in a forward direction and blocking light traveling in a reverse direction. An optical isolator according to the present embodiment includes the polarizing glass described above. The optical isolator is not particularly limited; however, a free-space optical isolator and a pigtail optical isolator can be provided as examples.

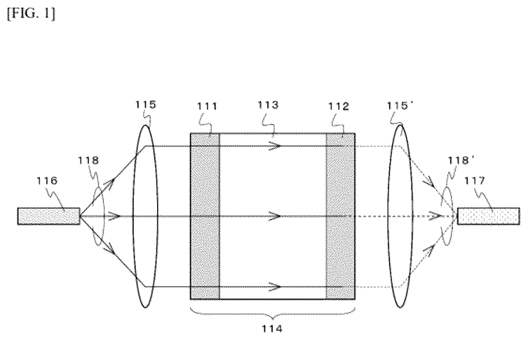

FIG. 1 is a schematic side cross-sectional view schematically showing an optical system of the free-space optical isolator. In the figure, reference numerals 111 and 112 denote polarizing elements, reference numeral 113 denotes a Faraday rotator, reference numeral 114 denotes an optical isolator composed of the polarizing elements 111 and 112 and the Faraday rotator 113, reference numerals 115 and 115′ denote lenses, reference numeral 116 denotes an optical fiber, reference numeral 117 denotes a light source such as a semiconductor laser, reference numerals 118 and 118′ denote groups of lines schematically showing the light flux of return light returning to the light source 117, and particularly, reference numeral 118′ denotes the light flux after the return light has transmitted through the polarizing element 112. The polarizing glass according to the present embodiment can be used as the polarizing elements 111 and 112. In the optical isolator 114 shown in FIG. 1, the polarization transmission axes of the polarizing elements 111 and 112 are disposed to form an angle of 45 degrees with each other, and the optical path length of the optical isolator 114 is set such that the polarization plane rotation angle of the Faraday rotator 113 is 45 degrees. In such a configuration, a light flux (not shown) emitted from the light source 117 is converted into a parallel light flux by the lens 115′, and only light having polarization in a direction parallel to the polarization transmission axis of the polarizing element 112 is incident on the Faraday rotator 113. The polarization direction of the light incident on the Faraday rotator 113 is rotated by 45 degrees due to the Faraday effect caused by a permanent magnet (not shown). As described above, since the polarization transmission axes of the polarizing elements 111 and 112 form an angle of 45 degrees with each other, the polarization direction of the light that has transmitted through the Faraday rotator 113 coincides with the polarization transmission axis of the polarizing element 111. Therefore, the light that has transmitted through the Faraday rotator 113 transmits through the polarizing element 111 with substantially no loss, is converged by the lens 115, and is incident on the optical fiber 116.

Meanwhile, the return light flux 118 that is reflected by the optical fiber 116 or an optical element or the like (not shown) disposed in a rear stage of the optical fiber 116 and returns to the light source returns to the light source 117 via an optical path opposite to that of the light flux emitted from the light source 117 described above; however, in this case, due to the non-reciprocity of the Faraday rotator 113, the polarization direction of the return light flux 118 after the return light flux has transmitted through the Faraday rotator 113 forms an angle of 90 degrees with the polarization transmission axis of the polarizing glass 112 (hereinafter, the axis in this direction will be referred to as the “polarization extinction axis”), so that the optical energy of the return light flux 118 is greatly lost when transmitting through the polarizing element 112.

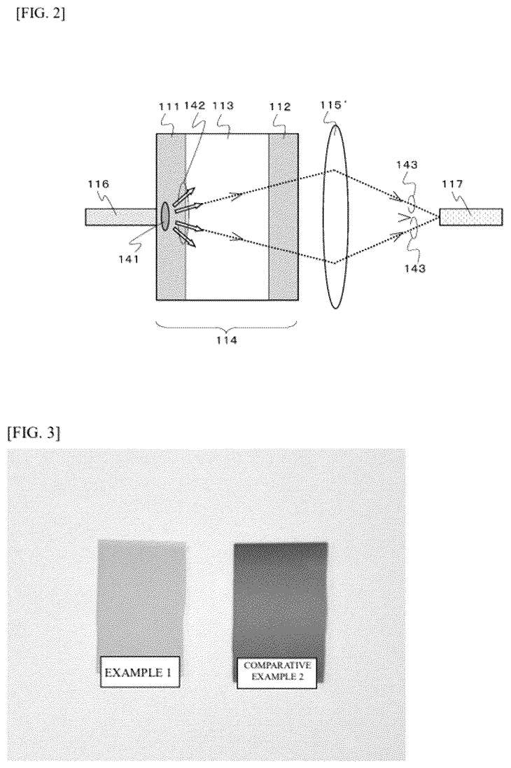

By the way, in recent years, due to a demand for miniaturization of optical components, a so-called pigtail optical isolator becomes mainstream. FIG. 2 is a schematic side cross-sectional view schematically showing an optical system of the pigtail optical isolator. In the figure, reference numeral 141 denotes a shape-anisotropic metal particle contained in the polarizing element 111, reference numeral 142 denotes an arrow schematically showing a propagation direction of scattered light, and reference numeral 143 denotes an optical path of return light flux. In the pigtail optical isolator as well, the polarizing glass according to the present embodiment can be used as the polarizing elements 111 and 112.

The optical system of the pigtail optical isolator differs from the optical system of the free-space optical isolator shown in FIG. 1 in that (1) the optical fiber 116 is directly coupled to the polarizing element 111 and (2) there is only one lens. As a result, the optical path of the return light flux 143 is different between both isolators; however, the configuration of the optical isolator 114 is substantially the same.

### EXAMPLES

Hereinafter, the present invention will be described in more detail with reference to Examples. However, the present invention is not limited to modes shown in Examples.

### Example 1

A polarizing glass was obtained by the following steps (A) to (D). Metallic Ag particles deposited on the surface of the obtained polarizing glass were observed using TEM.

### [(a) Mixing and Melting of Glass Raw Materials]

SiO₂, H₃BO₃, Al(OH)₃, Li₂CO₃, Na₂CO₃, K₂CO₃, KNO₃, ZrO₂, TiO₂, Nb₂O₅, NaCl, NaBr, and AgCl were used as glass raw materials, and these raw materials were placed in a 5-liter platinum crucible, melted at about 1450° C., then cast into a metal mold to be shaped, and slowly cooled to room temperature. A glass substrate material having a composition shown in Example 1 of Table 1(1) was obtained. Table 1(2) shows the chemical equivalents of Ag, Cl, and Br in the glass substrate. In Table 1(2), the chemical equivalents of Ag, Cl, and Br were calculated based on that the atomic weight of Ag being 107.87, the atomic weight of Cl being 35.45, and the atomic weight of Br being 79.9.

### [(B) Deposition of Silver Halide Particles]

The glass substrate material obtained in the above (A) was heat-treated at 704° C. for about 8 hours to deposit AgClBr particles in the glass, and then cut to a size of 120 mm in width, 250 mm in length, and 6 mm in thickness to produce a preform.

### [(C) Drawing of Glass Substrate Material]

The preform obtained in the above (B) was heated in a drawing furnace, and drawn at a tensile force of 32.0 MPa. Accordingly, a plurality of the silver halide particles (AgClBr) contained in the glass changed from a spherical shape to an elongated shape (substantially ellipsoidal shape) extending long along a drawing direction.

### [(D) Reduction]

A glass film having a thickness of about 0.6 mm obtained in the above-described drawing step (C) was cut in a rectangular shape, polished to a thickness of 0.2 mm, and heat-treated in a hydrogen atmosphere at 440° C. for about 7 hours to reduce the unidirectionally drawn silver halide particles to silver particles. The polarizing glass containing metallic Ag particles as the oriented and dispersed shape-anisotropic metal particles in the surface layer of the glass substrate was obtained.

### <Observation in TEM Photograph>

The surface of the obtained polarizing glass was observed using transmission electron microscope (TEM) photographs. It was confirmed that the metallic Ag particles existed on the surface of the polarizing glass as the oriented and dispersed shape-anisotropic metal particles.

### Comparative Example 1

A glass substrate material having a composition shown in Comparative Example 1 of Table 1(1) was obtained according to the same procedure as in the above (A). Table 1(2) shows the chemical equivalents of Ag, Cl, and Br in the glass substrate. Incidentally, the composition of Comparative Example 1 is the same as the glass composition shown in Example 10 of WO 2007/119794.

The obtained glass substrate material was heat-treated according to the same procedure as in the above (B), and then heated and drawn according to the same procedure as in the above (C). A polarizing glass was obtained according to the same procedure as in the above (D). The observation of TEM photographs similar to those in Example 1 confirmed that metallic Cu particles existed on the surface of the polarizing glass as the oriented and dispersed shape-anisotropic particles.

### Comparative Example 2

A glass substrate material having a composition shown in Comparative Example 2 of Table 1(1) was obtained according to the same procedure as in the above (A). Table 1(2) shows the chemical equivalents of Ag, Cl, and Br in the glass substrate. The obtained glass substrate material was heat-treated according to the same procedure as in the above (B), and then heated and drawn according to the same procedure as in the above (C). A polarizing glass was obtained according to the same procedure as in the above (D). The observation of TEM photographs similar to those in Example 1 confirmed that metallic Ag particles existed on the surface of the polarizing glass as the oriented and dispersed shape-anisotropic particles.

TABLE 1(1)

| | Glass Composition (mass %) | | |
|---|---|---|---|
| | | Comparative | Comparative |
| | Example 1 | Example 1 | Example 2 |
| SiO₂ | 55.1 | 58.6 | 57.2 |
| B₂O₃ | 16.3 | 20.4 | 16.3 |
| AlF₃ | | 2.2 | |
| Al₂O₃ | 5.4 | 7.0 | 7.1 |
| Li₂O | 1.8 | | 1.8 |
| Na₂O | 4.5 | 10.1 | 4.7 |
| K₂O | 5.8 | | 5.9 |
| Y₂O₃ | | 0.2 | |
| ZrO₂ | 6.1 | | 5.2 |
| TiO₂ | 1.6 | | 1.0 |
| Nb₂O₅ | 2.6 | | |
| SnO | | 0.1 | |
| Ag | 0.23 | | 0.23 |
| Cu | | 0.5 | |
| Cl | 0.40 | 0.9 | 0.40 |
| Br | 0.17 | | 0.17 |
| Total | 100 | 100 | 100 |
| Li₂O + | 12.1 | 10.1 | 12.4 |
| Na₂O + K₂O | | | |
| TiO₂ + | 4.2 | 0.0 | 1.0 |
| Nb₂O₅ | | | |

TABLE 1(2)

| | | | Comparative | Comparative |
|---|---|---|---|---|
| | | Example 1 | Example 1 | Example 2 |
| mass % | Ag | 0.23 | | 0.23 |
| | Cl | 0.40 | 0.90 | 0.40 |
| | Br | 0.17 | | 0.17 |
| chemical | Ag | 0.0021 | 0.0000 | 0.0021 |
| equivalent | Cl | 0.0113 | 0.0254 | 0.0113 |
| | Br | 0.0021 | 0.0000 | 0.0021 |

### <Chemical Durability: Water Resistance Dw>

In Example 1 and Comparative Example 1, the glass substrate materials obtained in the above (A) were evaluated for the water resistance Dw. Namely, powdered glass (particle size 425 to 600 μm) of a mass equivalent to the specific gravity of the glass substrate material was placed in a platinum basket, the platinum basket was immersed in a round bottomed flask of glass quartz containing 80 mL of pure water (pH=6.5 to 7.5), the powdered glass was treated in a boiling water bath for 60 minutes, and the mass loss rate (%) was calculated. The mass loss rate of the glass substrate material of Example 1 was 0.03%, and the mass loss rate of the glass substrate material of Comparative Example 1 was 0.04% or more.

### <Chemical Durability: Acid Resistance Da>

In Example 1 and Comparative Example 1, the glass substrate material obtained in the above (A) were evaluated for the acid resistance Da. Namely, powdered glass (particle size 425 to 600 μm) of a mass equivalent to the specific gravity of the glass substrate material was placed in a platinum basket, the platinum basket was immersed in a round bottomed flask of glass quartz containing 80 mL of 0.01 mol/L nitric acid water solution, the powdered glass was treated in a boiling water bath for 60 minutes, and the mass loss rate (%) was calculated. The mass loss rate of the glass substrate material of Example 1 was 0.07%, and the mass loss rate of the glass substrate material of Comparative Example 1 was 0.21% or more.

<Effect of Nb₂O₅ on Reducing Photochromic Properties>

In Example 1 and Comparative Example 2, the glass substrate materials were produced according to the procedure shown in the above (A).

The obtained glass substrate materials were heat-treated according to the same procedure as in the above (B), and then heated and drawn according to the same procedure as in the above (C) to obtain glass films. The glass films were cut to a length of about 20 mm. The glass film of Comparative Example 2 and the glass film of Example 1 were placed side by side, and irradiated with ultraviolet light having a wavelength of mainly 365 nm at an illuminance of 50 mW/cm² for 10 minutes using an ultraviolet irradiator. The glass films after irradiation with ultraviolet light are shown in FIG. 3. In addition, the spectral transmittance of the glass films before and after irradiation with ultraviolet light was measured using a spectrophotometer at wavelengths of 400 nm, 1310 nm, and 1550 nm. Table 2 shows the ratio of the transmittance after irradiation with ultraviolet light to the transmittance before irradiation.

As shown in FIG. 3, the sample of Comparative Example 2 that did not contain Nb₂O₅ was discolored to be black due to light irradiation, whereas discoloration of the sample of Example 1 due to light irradiation was suppressed.

TABLE 2

| | | |
|---|---|---|
| Wavelength | Example 1 | Comparative Example 2 |

| | | | |
|---|---|---|---|
| 400 | nm | 99% | 83% |
| 1310 | nm | 100% | 92% |
| 1550 | nm | 100% | 94% |

As shown in Table 2, in the composition that did not contain Nb₂O₅ and contained a low amount of TiO₂ (Comparative Example 2), the ratio of the transmittance after irradiation with ultraviolet light to the transmittance before irradiation greatly decreased to 83% at a visible short wavelength of 400 nm, whereas in the composition containing Nb₂O₅(Example 1) in which the ratio was 99%, the transmittance was maintained. At 1310 nm that is the wavelength band used in optical communication, the ratio of the transmittance after irradiation with ultraviolet light to the transmittance before irradiation decreased to 92% in Comparative Example 2, whereas the transmittance was maintained in Example 1 in which the ratio was 100%. At a wavelength of 1550 nm, the ratio of the transmittance after irradiation with ultraviolet light to the transmittance before irradiation decreased to 94% in Comparative Example 2, whereas the transmittance was maintained in Example 1 in which the ratio was 100%. Photochromism was significantly suppressed by containing Nb₂O₅.

### <Extinction Ratio and Insertion Loss>

An anti-reflection film (AR coat) was applied to one surface of each of the polarizing glasses obtained in Example 1 and Comparative Example 2 to reduce the reflectance due to the refractive index of the polarizing glass. The anti-reflection film was formed as a multi-layer film composed of a metal oxide layer such as TiO₂ or Ta₂O₅ and a SiO₂ layer. Since the polarizing glass used in optical isolators is often used in such a manner that a 0-degree product (a polarizing glass product that is cut such that the polarization transmission axis of a light component transmitting through the polarizing glass is parallel to the outer edge of the Faraday rotator) is affixed to one surface of a Faraday element (garnet) and a 45-degree product (a polarizing glass product that is cut such that the 0-degree product and the polarization transmission axis form an angle of 45 degrees) is affixed to the other surface using an adhesive, in most cases, only one surface comes into contact with the atmosphere. For the above reasons, the AR film of the polarizing glass was provided on only one surface.

A rectangular polarizing glass with a thickness of 0.2 mm and an AR coat applied to one surface was affixed to an adhesive tape that was peeled off when irradiated with ultraviolet light (UV light), and cut to a product size of 11 mm square, and the polarizing glass was peeled off from the adhesive tape by irradiating the adhesive tape with UV light. The extinction ratio and the insertion loss of the polarizing glass were measured when the wavelength of the laser light source was set to 1270 nm and the distance (measurement distance) between the polarizing glass and the power meter of the detector was set to 5 mm, and when the wavelength of the laser light source was set to 1650 nm and the measurement distance was set to 300 mm. Results are shown in Table 3.

TABLE 3

| | | Measurement | | | Comparative |
|---|---|---|---|---|---|
| | Wavelength | Distance | | Example 1 | Example 2 |
| Extinction | 1270 nm | 5 | mm | 38.60 | 36.91 |
| Ratio | | | | | |
| (dB) | 1650 nm | 300 | mm | 56.80 | 53.65 |
| Insertion Loss | 1270 nm | 5 | mm | 0.187 | 0.241 |
| (dB) | 1650 nm | 300 | mm | 0.196 | 0.232 |

In Comparative Example 2 in which Nb₂O₅ was not contained and the amount of a TiO₂ was 1.0%, the extinction ratio at a wavelength of 1270 nm and a measurement distance of 5 mm was 36.91 dB lower than that in Example 1. In addition, the extinction ratio at a wavelength of 1650 nm and a distance of 300 mm in Comparative Example 2 was also 53.65 dB lower than that in Example 1.

The insertion loss of Comparative Example 2 was 0.241 dB when the wavelength was 1270 nm and the measurement distance was 5 mm, which was higher than that in Example 1. The insertion loss at a wavelength of 1650 nm and a distance of 300 mm was 0.232 dB higher than that in Example 1. In Comparative Example 2 in which Nb₂O₅ was not contained and the amount of TiO₂ was 1.0%, it is presumed that the insertion loss was increased due to the influence of photochromism.

It should be considered that the embodiment disclosed herein is provided as an example in all respects and does not limit the present invention. The scope of the present invention is defined not by the above description but by the claims, and is intended to include all modifications within the concept and scope of the claims and the equivalents.

For example, by performing composition adjustment described in the specification on the glass composition provided above as an example, the polarizing glass according to one aspect of the present invention can be produced.

In addition, of course, two or more of the items described in the specification as examples or preferred ranges can be arbitrarily combined.

What is claimed is:

1. A polarizing glass comprising:
shape-anisotropic metal particles oriented and dispersed in at least a surface layer of a glass substrate,
wherein the glass substrate contains, by mass %,
SiO₂: 50.0 to 60.0%,
B₂O₃: 10.0 to 25.0%,
Al₂O₃: 3.0 to 10.0%,
a total amount of Li₂O, Na₂O, and K₂O [Li₂O+Na₂O+K₂O]: 5.0 to 20.0%,
ZrO₂: 2.0 to 8.0%,
TiO₂: 0.1 to 5.0%,
Nb₂O₅: 0.1 to 5.0%,
a total amount of TiO₂ and Nb₂O₅[TiO₂+Nb₂O₅]: 0.2 to 10.0%,
Ag, and
Cl and/or Br: equal to or larger than a chemical equivalent of Ag, and
the shape-anisotropic metal particles are metallic Ag particles.

2. An optical isolator comprising:
the polarizing glass according to claim 1.
